(19) United States
(12) Patent Application Publication
(10) Pub. No.: US 2023/0191938 A1
(43) Pub. Date: Jun. 22, 2023

(54) CHARGING SYSTEM FOR ELECTRIC VEHICLES

(71) Applicant: EPS E-MOBILITY S.R.L., Milano (IT)

(72) Inventors: Francesco LAMBERTI, MILANO (IT); Giorgio CRUGNOLA, VARESE (IT); Marco TODESCHINI, LECCO (IT); Daniele ROSATI, TRECATE (IT); Nicola VANINETTI, DELEBIO (IT)

(73) Assignee: FREE2MOVE ESOLUTIONS S.P.A., MILANO (IT)

(21) Appl. No.: 17/999,285

(22) PCT Filed: May 17, 2021
(86) PCT No.: PCT/IB2021/054204

§ 371 Date: Nov. 18, 2022

(30) Foreign Application Priority Data
May 21, 2020 (IT) 102020000011944

(51) Int. Cl. B60L 53/67; B60L 53/62

(52) U.S. Cl. CPC B60L 53/67; B60L 53/62; B60L 2210/30

(57) ABSTRACT

A charging system for electric vehicles comprising including: a plurality of charging stations each capable of charging an electric vehicle, a first converter supplied with electricity by a source, a first connection network connecting the first converter to all the charging stations, the first converter and the first connection network being able to simultaneously charge a first group of electric vehicles having similar charge levels, a second power supply of electricity, a second connection network connecting the power supply to a second group of charging stations, comprising including at least one charging station, the second power supply and the second connection network being able to charge a second group of electric vehicles, comprising including at least one electric vehicle, electric vehicles belong to the second group having charge levels substantially different from the charge levels of the first set.

The present invention relates to a system for the charging of electric vehicles, for example motor vehicles, of the type specified in the preamble of the first claim.

In recent years, there are more and more vehicles, particularly motor vehicles, which mainly or exclusively use electricity for their propulsion.

Such vehicles have enormous environmental and economic benefits for the end user.

Electric energy is supplied to the engines of said vehicles by internal electric batteries.

The internal electric batteries, at the same time, run out of their electric charge and are chargeable by connecting to a charging system connected to a source of electricity, such as the electricity grid.

The known art described includes some important drawbacks.

In fact, said charging systems are very complex and expensive, in particular due to the fact that they must be connected to a high-power electrical network and must include converters for the passage of electric current and its transformation from alternating current to direct current.

Patent application US 2013/314037 A1 partially solves said drawbacks by providing a charging system including a single AC/DC converter for a plurality of recharging stations. However, said system has problems in charging vehicles with different states of charge and also in charging several cars at the same time.

In this situation, the technical task underlying the present invention is to devise an electric vehicle charging system capable of substantially obviating at least part of the aforementioned drawbacks.

Within the scope of said technical task, an important object of the invention is to obtain a simple and economical electric vehicle recharging system. Another important object of the invention is to provide a high-power electric vehicle charging system.

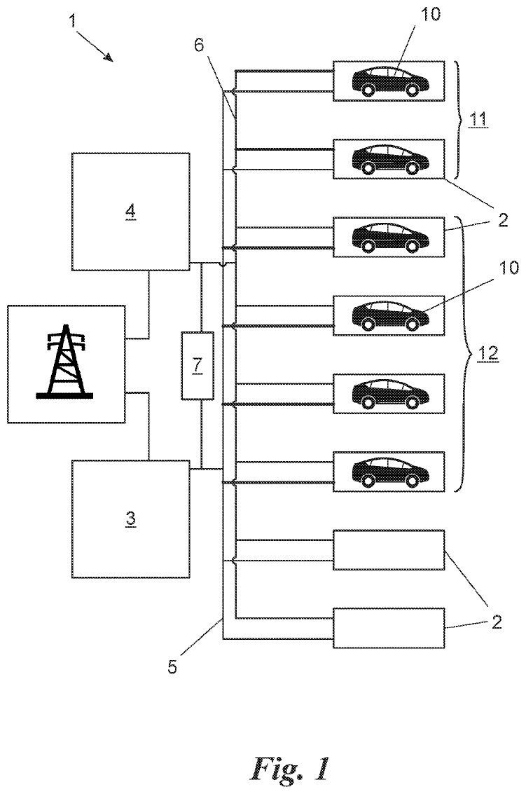

The technical task and the specified aims are achieved by an electric vehicle recharging system as claimed in the annexed claim 1. Preferred technical solutions are highlighted in the dependent claims. The characteristics and advantages of the invention are clarified below by the detailed description of preferred embodiments of the invention, with reference to the accompanying figures, in which:
the FIG. 1 shows a diagram of the charging system for electric vehicles according to the invention.

In the present document, the measurements, values, shapes and geometric references (such as perpendicularity and parallelism), when associated with words like “about” or other similar terms such as “approximately” or “substantially”, are to be considered as except for measurement errors or inaccuracies due to production and/or manufacturing errors, and, above all, except for a slight divergence from the value, measurements, shape, or geometric reference with which it is associated. For instance, these terms, if associated with a value, preferably indicate a divergence of not more than 10% of the value.

Moreover, when used, terms such as “first”, “second”, “higher”, “lower”, “main” and “secondary” do not necessarily identify an order, a priority of relationship or a relative position, but can simply be used to clearly distinguish between their different components.

Unless otherwise specified, as results in the following discussions, terms such as “treatment”, “computing”, “determination”, “calculation”, or similar, refer to the action and/or processes of a computer or similar electronic calculation device that manipulates and/or transforms data represented as physical, such as electronic quantities of registers of a computer system and/or memories in, other data similarly represented as physical quantities within computer systems, registers or other storage, transmission or information displaying devices.

The measurements and data reported in this text are to be considered, unless otherwise indicated, as performed in the International Standard Atmosphere ICAO (ISO 2533:1975).

With reference to the figures, the charging system for electric vehicles according to the invention is globally indicated with the number 1.

It is capable of charging electric vehicles 10, in particular motor vehicles. More specifically, the charging system 1 is used for fleets of vehicles, for example of the same company or car-sharing or similar. The term electric vehicles 10 means vehicles with at least partially electric propulsion, equipped with an internal electric battery that can also be charged from the outside.

The recharging system 1 for electric vehicles 10 comprises a plurality of recharging stations 2 each suitable for recharging preferably an electric vehicle 10 and therefore the electric battery inside it.

The recharging stations are preferably in number between 5 and 20, more preferably between 10 and 20.

The recharging system 1 also preferably comprises a first converter 3 powered by electricity from a source, such as the electricity network or directly from a generator.

The first converter 3 is preferably capable of converting the alternating current into direct current. Furthermore, it is preferably of the bidirectional type, or rather, capable of supplying electrical energy from the source to the internal electric batteries of the electric vehicles 10, and to send electric energy from the internal electric batteries of the electric vehicles 10 to the source, in particular if the latter consists from the power grid.

Furthermore, the first converter 3, preferably, has a power greater than 1 MW, more preferably between 1.5 and 2.5 MW. Finally, the first converter 3 is preferably contained in a single container.

Between the first converter 3 and the charging stations 2, preferably all the charging stations, there is conveniently a first connection network 4 capable of transferring said electrical energy.

Along the first connection network 4, obviously having at least two polarity wires, there are any fuses, variators, switches and similar, preferably before each charging station 2.

The charging system 1 also preferably comprises a second power supply 5 preferably comprising, and more preferably consisting of, a second converter supplied with electrical energy from a source, such as the electrical network or directly from a generator. The second converter is preferably capable of converting alternating current into direct current.

The second power supply 5 can alternatively be a high-capacity battery. In any case, preferably, the second power supply 5 is of the bidirectional type, that is, suitable both for supplying electricity to the internal electric batteries of electric vehicles 10 and for drawing electric energy from the internal electric batteries of electric vehicles 10.

Furthermore, the second power supply 5 preferably has a power lower than the power of the first converter. Finally, the second feeder 5 is preferably contained in a single container.

Between the second power supply 5 and at least one charging station 2, preferably there is a plurality of charging stations 2 and more preferably in all charging stations 2, there is conveniently a second connection network 6 capable of transferring said electrical energy.

Along the second connection network 6, obviously having at least two polarity wires, there are any fuses, variators, switches and similar, preferably before each charging station 2. Furthermore, said first and second networks 4 and 6 can have a line, especially the negative one, in common.

Consequently, and preferably, all the recharging stations 2 will be affected by the power supply of the first connection network 4 and one, some or all of them will also be affected in addition by the power supply of the second connection network 6.

Furthermore, suitably, the first and second network 4 and 6 refer to the same connector in the charging station 2 which is connectable to the electric vehicle 10. Accordingly, the mechanical connection of the connector to the vehicle 10 does not vary if it is used the first or second network 4 and 6.

The charging system 1 preferably also comprises control means 7, capable of connecting and disconnecting electrically, and preferably only electrically and not mechanically, each individual vehicle 10, preferably independently of the others, from the connections with the first or second network 4 and 6.

The control means 7 are therefore also capable of varying, substantially without interruption of supply or withdrawal of energy, the power supply of one or more electric vehicles 10 from the first or second network 4 and 6. The control means 7 are, in fact, preferably capable of obtaining responses and actions in time intervals of the order of magnitude of tenths of a second.

The control means 7 are of the electronic or electrical type and can be easily realized by the person skilled in the art and can act for example by opening and closing switches placed according to the first or second network 4 and 6.

The operation of the charging system 1 previously described in structural terms is the following.

It defines a new and innovative method of charging electric vehicles 10, preferably implemented by means of the system 1 described above.

A fleet of electric vehicles 10, composed of at least one vehicle 10, is placed in charged.

The fleet is preferably composed of a first group 11 of electric vehicles 10 having similar charge levels. With the term similar it is preferably meant that their percentages of charge do not vary mutually by more than 20 percentage points %, with the percentage with respect to the maximum charge that the vehicle 10 can have, more preferably with the term similar it is preferable to mean that their charge percentages do not vary by more than 10% with respect to the maximum charge that the vehicle 10 can have.

The fleet is preferably composed of a second group 12 of one or more electric vehicles 10 having charge levels substantially different from the charge levels of the vehicles belonging to the first group 11. The term substantially different is preferably intended to mean the reciprocal of similar, previously defined. The vehicles 10 therefore have charge levels or similar or substantially different, preferably there are no other possibilities, as defined in the present text.

The first group 11 of electric vehicles 10, according to the new method, is connected to charging stations 2 connected at least to the first network 4 and advantageously electrically charged or discharged simultaneously, more preferably substantially with the same power for each vehicle.

Furthermore, suitably, together and simultaneously with the first group 11, the second assembly 12 of electric vehicles is also electrically charged or discharged. The second set 12 of electric vehicles 10 is preferably connected to charging stations 2 connected both to the first network 4 and to the second network 6. The first group 11 is then loaded by the first converter 3, while the second group 12 is recharged by the second power supply 5.

Furthermore, preferably, the electric vehicles 10 belonging to the second group 12 are automatically moved to the first group 11, and become part of it, through the disconnection from the second connection network 6 and the connection to the first connection network 5, when they reach levels of similar charge levels from said charge levels of said first group 11.

Said passage from one network to another preferably takes place through said control means 7 and preferably occurs only at an electrical level and not at a mechanical level.

The charging system 1 and the charging method according to the invention achieve important advantages.

In fact, the recharging system 1 allows not to use a single converter for each electric vehicle 10, but two converters are sufficient for the whole fleet and allow the charging of vehicles at different charge levels.

This simplification conveniently allows not only to reduce costs but also to optimize the supply of ancillary services through the management of a single communication interface towards the electricity network and the TSO/DSO respectively. This solution proves to be extremely effective and more efficient (single conversion stage) than the solutions currently proposed by the market that require an additional SW level of aggregation.

Furthermore, the charging system 1 allows to use a high power.

The invention is susceptible of variants falling within the scope of the inventive concept defined by the claims.

In this context, all the details can be replaced by equivalent elements and the materials, shapes and dimensions can be any.

1. A charging system for electric vehicles comprising:
a plurality of charging stations each designed to recharge one of said electric vehicles,
a first converter powered by electricity from a source,
a first connection network connecting said first converter to all said charging stations,
said first converter and said first connection network being designed to simultaneously charge a first group of said electric vehicles, said electric vehicles belonging to said first group having similar charge levels to each other,
a second power supply unit supplying electricity,
a second connection network connecting said power supply unit to a second collection of charging stations, comprising at least one of said charging stations,
said second power supply unit and said second connection network being designed to charge a second group of said electric vehicles, comprising at least one of said electric vehicles, said electric vehicles belonging to said second group having charge levels basically different from said charge levels of said first group.

2. The charging system according to claim 1, wherein said second collection comprises all said charging stations.

3. The charging system according to claim 1, wherein said first converter is a bidirectional converter.

4. The charging system according to claim 1, wherein said second power supply unit is bidirectional.

5. The charging system according to claim 1, comprising control means, designed to disconnect said vehicles from said second connection network and to connect them to said first connection network.

6. The charging system according to claim 1, wherein said second power supply unit comprises a second converter powered by a source.

7. The charging system according to claim 1, wherein said first connection network and said second connection network adjoining the same said charging station adjoin the same connector that can be connected to one of said electric vehicles.

8. A procedure for recharging electric vehicles using a charging system,
said charging system comprising:
a plurality of charging stations each designed to recharge one of said electric vehicles,
a first converter powered by electricity from a source,
a first connection network connecting said first converter to all said charging stations,
a second power supply unit powered by electricity from one source,
a second connection network connecting said second power supply unit to a second collection of charging stations, comprising at least one of said charging stations,
and said procedure comprises simultaneously recharging:
a first group of said electric vehicles having similar charge levels to each other using said first converter and said first connection network,
a second group of said electric vehicles, comprising at least one of said electric vehicles said electric vehicles belonging to said second group having charge levels basically different to said charge levels of said first group, using said second power supply unit and said second connection network.

9. The charging procedure according to claim 8, wherein said electric vehicles belonging to said second group are automatically moved to said first group by disconnecting from said second connection network and connecting to said first connection network, when they reach similar charge levels to said charge levels of said first group.

10. The charging procedure according to claim 9, wherein said automatic movement from said first connection network and said second connection network takes place without mechanically moving the connector between said first connection network and said second connection network and by electrically opening and closing internal connections to said networks.

11. The charging procedure according to claim 8, wherein said procedure consists in simultaneously recharging:
said first group of said electric vehicles having similar charge levels to each other using said first converter and said first connection network, and
said second group of said electric vehicles, comprising at least one of said electric vehicles said electric vehicles belonging to said second group having charge levels basically different to said charge levels of said first group, using said second power supply unit and said second connection network
